(19) United States
(12) Patent Application Publication
(10) Pub. No.: US 2026/0186653 A1
(43) Pub. Date: Jul. 2, 2026

(54) STORING AND RETRIEVING CHECKPOINT VALUES USING DELTA COMPUTATION AND COMPRESSION

(71) Applicant: Micron Technology, Inc., Boise, ID (US)

(72) Inventor: David Andrew Roberts, Wellesley, MA (US)

(21) Appl. No.: 19/409,488

(22) Filed: Dec. 4, 2025

Related U.S. Application Data
(60) Provisional application No. 63/740,066, filed on Dec. 30, 2024.

(51) Int. Cl. G06F 3/06

(52) U.S. Cl. CPC G06F 3/0608; G06F 3/0659; G06F 3/0679

(57) ABSTRACT

Methods, systems, and devices for storing and retrieving checkpoint values using delta computation and compression are described. Techniques described herein may enable a memory system may compute deltas between initial checkpoint values and updated checkpoint values associated with values of weights of an artificial intelligence (AI) model. The memory system may compress and store the deltas. In some examples, the memory system may perform delta computation and compression simultaneously while receiving the updated checkpoint values (e.g., without storing the updated checkpoint values in a volatile memory of the memory system in accordance with a first operation mode) or after receiving the updated checkpoint values (e.g., after storing the updated checkpoint values in a volatile memory of the memory system in accordance with a second operation mode). In some examples, the memory system may switch between the first operation mode and the second operation mode.

### CROSS REFERENCE

The present Application for Patent claims priority to U.S. patent application Ser. No. 63/740,066 by Roberts, entitled “STORING AND RETRIEVING CHECKPOINT VALUES USING DELTA COMPUTATION AND COMPRESSION,” filed Dec. 30, 2024, which is assigned to the assignee hereof, and which is expressly incorporated by reference in its entirety herein.

### TECHNICAL FIELD

The following relates to one or more systems for memory, including storing and retrieving checkpoint values using delta computation and compression.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports storing and retrieving checkpoint values using delta computation and compression in accordance with examples as disclosed herein.

FIG. 2 shows an example of a system that supports storing and retrieving checkpoint values using delta computation and compression in accordance with examples as disclosed herein.

FIG. 3 shows an example of a process flow that supports storing and retrieving checkpoint values using delta computation and compression in accordance with examples as disclosed herein.

FIG. 4 shows a block diagram of a memory system that supports storing and retrieving checkpoint values using delta computation and compression in accordance with examples as disclosed herein.

FIGS. 5 and 6 show flowcharts illustrating a method or methods that support storing and retrieving checkpoint values using delta computation and compression in accordance with examples as disclosed herein.

### DETAILED DESCRIPTION

In some examples, a memory system may store values of weights of an artificial intelligence (AI) model (e.g., a machine learning (ML) model, a neural network). For example, a host system may perform a training procedure on the AI model to generate values of weights (e.g., parameters) of the AI model. The host system may output one or more commands to the memory system to store the values of the weights. In some examples, the host system may update the values of the weights (e.g., periodically as part of an additional training procedure) and may indicate the updated values of the weights to the memory system. For example, the host system may indicate checkpoint values associated with the weights (e.g., during the additional training procedure), and the memory system may compress and store the checkpoint values. However, the host system may instruct the memory system to store updated checkpoint values relatively often, which may result in relatively high storage use (e.g., to store each checkpoint value of each weight of the model).

Accordingly, techniques described herein may enable the memory system (e.g., a controller of the memory system) to compute deltas (e.g., differences) between one or more initial checkpoint values and one or more updated checkpoint values (e.g., rather than storing each updated checkpoint value in non-volatile memory). The memory system may accordingly compress and store the deltas, which may result in relatively less storage use as compared to compressing and storing each updated checkpoint value. In some examples, the memory system may perform delta computation and compression while receiving the updated checkpoint values in accordance with a first operation mode (e.g., without storing the updated checkpoint values in a volatile memory of the memory system that is external to the controller) or after receiving the updated checkpoint values in accordance with a second operation mode (e.g., after storing the updated checkpoint values in the volatile memory of the memory system that is external to the controller). In some examples, the memory system may switch between the first operation mode and the second operation mode (e.g., in response to a trigger).

In addition to applicability in memory systems as described herein, techniques for computing deltas for checkpoint values may be generally implemented to improve the performance of various electronic devices and systems (including AI applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling storage of updated values of weights of AI models, which may decrease processing or latency times and increase performance as a result of increasing an accuracy of the AI model, among other benefits.

Features of the disclosure are illustrated and described in the context of systems and architectures. Features of the disclosure are further illustrated and described in the context of process flows and flowcharts.

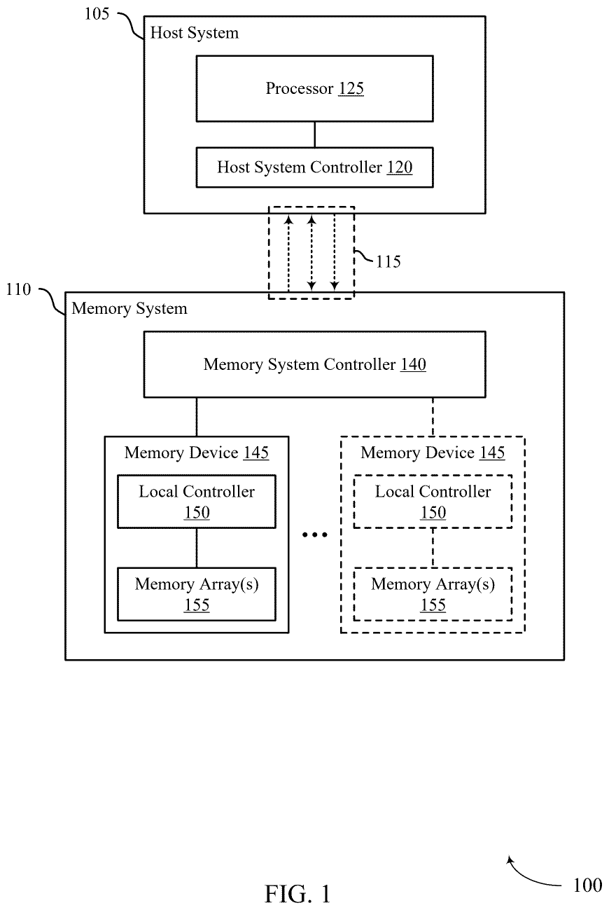

FIG. 1 shows an example of a system 100 that supports storing and retrieving checkpoint values using delta computation and compression in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof. In some examples, a memory system 110 (e.g., a memory array 155 of the memory system 110) may include one or more volatile memory devices 145 and/or one or more non-volatile memory devices 145.

A local controller 150 may include one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

In some examples of the system 100, a memory system 110 may compute deltas (e.g., differences) between one or more initial checkpoint values and one or more updated checkpoint values associated with values of weights of an AI model (e.g., values computed by a host system 105). The memory system 110 may accordingly compress and store the deltas, which may result in relatively less storage use as compared to compressing and storing each updated checkpoint value. For example, the memory system 110 may store the deltas in a non-volatile memory of the memory system 110 (e.g., a non-volatile memory external to the controller), which may enable the memory system 110 to restore the values of the weight in examples in which a power loss occurs (e.g., without the host system 105 re-computing the values of the weights).

In some examples, the memory system 110 may perform delta computation and compression simultaneously while receiving the updated checkpoint values in accordance with a first operation mode (e.g., without storing the updated checkpoint values in a volatile memory of the memory system 110 that is external to the controller of the memory system) or after receiving the updated checkpoint values in accordance with a second operation mode (e.g., after storing the updated checkpoint values in the volatile memory of the memory system 110 that is external to the controller). In some examples, the memory system 110 may switch between the first operation mode and the second operation mode (e.g., in response to a trigger).

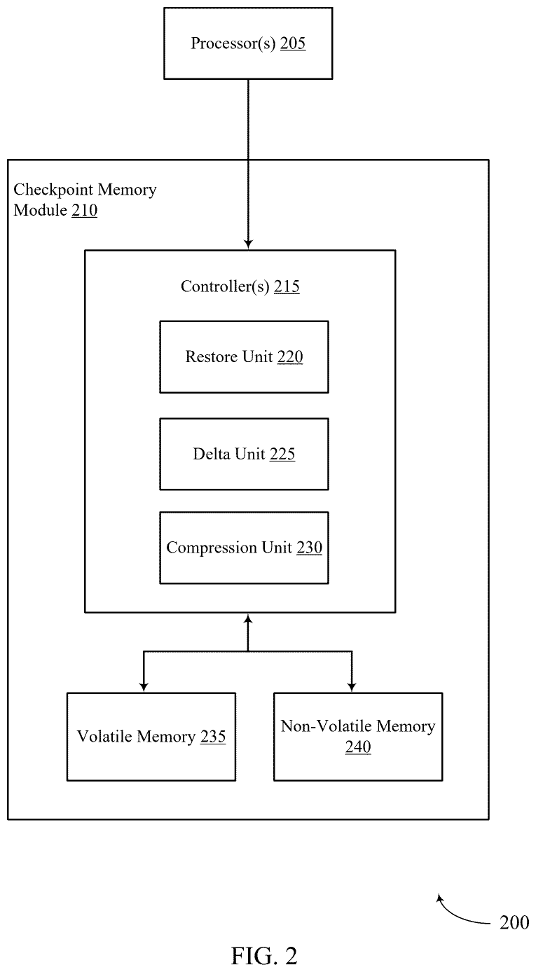

FIG. 2 shows an example of a system 200 that supports storing and retrieving checkpoint values using delta computation and compression in accordance with examples as disclosed herein. The system 200 may implement or may be implemented by aspects of the system 100. For example, the system 200 may include examples of one or more components implemented by a memory system 110, which may be examples of the corresponding device as described with reference to FIG. 1

In some examples, a computer system (e.g., a host system 105) may perform workloads that may use relatively large amounts of memory (e.g., high bandwidth memory (HBM) DRAM in GPUs). For example, the host system 105 may run a program to perform ML training (e.g., training to generate values of parameters such as a set of weights for an AI model, an ML model, a NN, and the like), which may take a relatively long time (e.g., months). The host system 105 may therefore save snapshots of a state of the program, such as checkpoint values of the set of weights, to a persistent or non-volatile storage (e.g., a non-volatile memory 240 of a memory system). The host system 105 may use the stored checkpoint values to recover the state of the program in examples in which an error occurs (e.g., software crashed or hardware faults that may cause memory errors, power loss, and the like). As described herein, checkpoint values may refer to intermediate values generated for the set of weights while a training procedure is being performed (e.g., values of the weights forming a snapshot of the program state during training of the model). For example, the checkpoint values may be values of the weights that are in-between an untrained value for a respective weight and a fully trained value for the respective weight, and may be associated with a state of the program or progress of training.

In some examples of the system 200, a memory system may include a checkpoint memory module 210 (e.g., a hybrid memory expansion module) that may include a storage memory (e.g., a persistent memory). The memory system may accordingly perform high efficiency checkpointing to copy checkpoint data (e.g., the checkpoint values) from a local memory of one or more accelerators (e.g., HBM) to the storage memory, such that computation (e.g., computation of the checkpoint values) may resume relatively more quickly than in systems without the checkpoint memory module 210.

In some examples, however, the checkpoint values may be large and/or frequent, and the memory system may use a relatively large amount of memory to store each checkpoint value received from the host system 105. For example, the memory system may use a relatively low compression ratio to compress and store a full checkpoint value, which may use more memory. Accordingly, techniques described herein may enable the memory system to store a difference (e.g., a delta) between successive checkpoint values (e.g., rather than full checkpoint values), which may enable the memory system to use a relatively higher compression ratio and therefore to use relatively less storage as compared to storing the full checkpoint values. For example, between training iterations of the AI performed model by the host system 105, the changes in values of the set of weights may be relatively incremental, which may enable the memory system to store relatively small values due to using a relatively higher compression ratio as compared to compression and storing full checkpoint values.

In some examples, to perform delta computation and compression, the memory system may receive checkpoint values for a set of weights of an AI model from the host system 105 (e.g., from one or more processor(s) 205 of the host system 105, such as CPUs and/or GPUs, that may perform a training operation) and may provide the checkpoint values to a checkpoint memory module 210 (e.g., a hybrid memory module with a volatile memory 235, a non-volatile memory 240, and an AI checkpoint accelerator). For example, the processor(s) 205 may indicate the checkpoint values via one or more commands to the memory system. The one or more commands may include an indication of an identifier (e.g., a file name, an iteration number, a name of the AI model, and the like) of the AI model, the set of weights, or both. Additionally, or alternatively, the one or more commands may indicate the checkpoint values within an address space of the AI model.

In some examples, a link between the processor(s) 205 and the checkpoint memory module 210 may be a relatively high bandwidth link, such as an ultra accelerator link (UALink), a peripheral component interconnect express (PCIe) link, a universal flash storage (UFS) link, a MIPI (e.g., M-PHY, UniPro) link, and/or a compute express (CXL) link. The checkpoint memory module 210 may include one or more controller(s) 215 of the memory system (e.g., a memory system controller 140). The memory system may store the checkpoint values from the host system 105 relatively quickly to the controller(s) 215 in a temporary storage of the controller(s) 215. For example, the controller(s) 215 may include a volatile memory with a relatively high bandwidth capability, which may enable the processor(s) 205 to resume the training operation. In some examples, however, the volatile memory of the controller(s) 215 may have relatively less storage space than a volatile memory 235 that is external to the controller(s) 215, and accordingly may not store a full set of checkpoint values received from the host system. Additionally, in some examples, data stored in the volatile memory of the controller(s) 215 may not be accessible by the processor(s) 205 (e.g., until the data is written to a volatile memory 235 or a non-volatile memory 240 external to the controller(s) 215).

The controller(s) of the checkpoint memory module 210 may include one or more units (e.g., a restore unit 220, a delta unit 225, and/or a compression unit 230) via which the checkpoint memory module 210 may compute and compress delta values. In some examples, operations described herein as being performed by one of the restore unit 220, the delta unit 225, or the compression unit 230 may be performed by one or more other units of the controller(s) 215. Additionally, or alternatively, one or more of the restore unit 220, the delta unit 225, and the compression unit 230 may be combined as a single unit which may perform the operations of the one or more of the restore unit 220, the delta unit 225, or the compression unit 230.

The restore unit 220 may restore previous values of the set of weights (e.g., previous checkpoint values) stored by the memory system. In some examples, the restore unit 220 may compute the previous values by retrieving initial values and one or more previous delta values (e.g., from the non-volatile memory 240) and computing a sum of the initial values and the previous delta values. In some examples (e.g., if the checkpoint values are a first set of checkpoint values received following storage of the initial values), the restore unit 220 may retrieve the initial values (e.g., without computing a sum).

The delta unit 225 may compute delta values for each checkpoint value received from the processor(s) 205. For example, the delta unit 225 may compute a difference between the checkpoint values and the previous values computed or retrieved by the restore unit 220. The delta unit 225 may quantize (e.g., round) the delta values. For example, the delta unit 225 may convert one or more floating point values of the delta values to lower range (e.g., few bits) floating point values or integer values. In some examples, if one or more of the quantized delta values are 0 (e.g., or close to 0), the memory system may refrain from compressing and storing the 0 or near- 0 values. In some examples, the quantization may be a lossy compression.

The compression unit 230 may compress the delta values using a lossless compression (e.g., a high-bandwidth compression and/or a relatively more simple compression such as run-length encoding (RLE)). The checkpoint memory module 210 may store the compressed delta values to the non-volatile memory 240 (e.g., external to the controller(s) 215, such as a NAND memory, or a NAND flash solid state drive (SSD)). The processor(s) 205 may accordingly resume the AI model training application. In some examples, the memory system may retain both of the previous checkpoint values and the new checkpoint values received from the host system, or may replace the previous checkpoint values with the one or more new checkpoint values (e.g., if DRAM space is exhausted).

In some examples, the memory system 110 may operate according to a first operation mode in which the checkpoint memory module 210 may perform the operations of the restore unit 220, the delta unit 225, and the compression unit 230 at least partially concurrently (e.g., simultaneously) with receiving the one or more commands from the processor(s) 205 indicating the checkpoint values. For example, the checkpoint memory module 210 may perform the operations of the restore unit 220, the delta unit 225, and the compression unit 230 for a first checkpoint value of a first checkpoint of an AI model while streaming (e.g., receiving) a second, subsequent checkpoint value of the first checkpoint from the processor(s) 205.

Additionally, or alternatively, the memory system may operate according to a second operation mode in which the checkpoint memory module 210 may store the checkpoint values in a volatile memory 235 (e.g., external to the controller(s) 215) while receiving the one or more commands from the processor(s) 205 indicating the checkpoint values. The memory system may retrieve the checkpoint values from the volatile memory 235 and may perform the operations of the restore unit 220, the delta unit 225, and the compression unit 230 after streaming of the checkpoint values is completed (e.g., the checkpoint values for a given checkpoint are stored in the volatile memory 235). In some examples, the first operation mode may use relatively less energy than the second operation mode. For example, the second operation mode may use an additional read command and an additional write command (e.g., to write and read the checkpoint values to and from the volatile memory 235), which may use relatively more energy.

In some examples, the memory system may switch between the first operation mode and the second operation mode. For example, the memory system may determine whether to operate according to the first operation mode or the second operation mode based on one or more criteria. For example, if a compression ratio used by the compression unit 230 satisfies a threshold compression ratio and/or if a bandwidth saturation of the non-volatile memory 240 satisfies a threshold bandwidth saturation, the memory system may switch from the first operation mode to the second operation mode (e.g., or vice-versa).

In some examples, the memory system may periodically store a full (e.g., uncompressed) checkpoint value (e.g., rather than a delta value). For example, the memory system may store a first checkpoint value and every N checkpoint values received from the processor(s) 205, and may use the stored checkpoint values as an initial value when computing one or more following delta values associated with one or more following checkpoint values received from the processor(s) 205. The value N may be a user-configured value. Such techniques may decrease a time for the memory system to recover a checkpoint value due to decreasing a quantity of delta values used to recover the checkpoint value.

In some examples (e.g., in the event of an error), the host system 105 may output a command to the memory system to restore the values of the weights. The command may indicate the identifier associated with the AI model, an index to the checkpoint to be restored, or both. The checkpoint memory module 210 may accordingly restore the checkpoint values by retrieving the initial checkpoint values and the delta values. In some examples (e.g., if the error is a power loss or DRAM corruption event), the checkpoint memory module 210 may restore the initial checkpoint values and delta values from the non-volatile memory 240 and may compute a sum of the initial checkpoint values and the delta values to generate the full checkpoint values (e.g., via the restore unit 220), or may indicate the initial checkpoint values and the delta values to the host system 105. In some examples (e.g., if the error is not a power loss or DRAM corruption event), the memory system may restore the checkpoint values from the volatile memory 235.

In some examples, by performing delta computation and compression, the memory system may reduce a frequency of full checkpoint values stored by the memory system (e.g., by storing delta values rather than checkpoint values), a bandwidth demand for checkpoint storage and restoring, size and capacity of backup capacitors or batteries used for volatile checkpoint storage, or a time used to write checkpoint values to and from persistent memory (e.g., the non-volatile memory 240). Such techniques may additionally increase a lifespan of the memory device as a result of decreasing a wear-out of the persistent memory (e.g., the non-volatile memory 240).

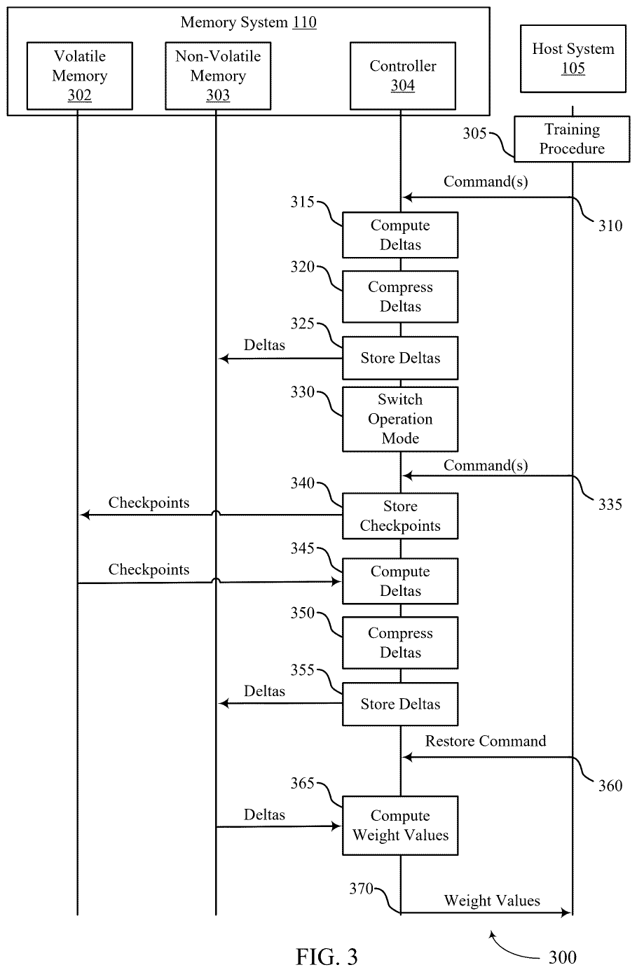

FIG. 3 shows an example of a process flow 300 that supports storing and retrieving checkpoint values using delta computation and compression in accordance with examples as disclosed herein. The process flow 300 may implement or may be implemented by aspects of the system 100 or the system 200. For example, the process flow 300 may be implemented by a memory system 110 and a host system 105, which may be examples of the corresponding devices as described with reference to FIG. 1.

In the following description of the process flow 300, the operations between the memory system 110 and the host system 105 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

At 305, the host system 105 may perform a training procedure for an AI model to generate values of a set of weights (e.g., parameters) of the AI model. In some examples, the host system 105 may generate one or more checkpoint values of the set of weights during the training procedure.

At 310, the memory system 110 may receive one or more commands from the host system 105 (e.g., at a controller 304 of the memory system 110). The one or more commands may indicate, to the memory system, the checkpoint values for the set of weights of the AI model. The one or more commands may include an identifier associated with the AI model and the checkpoint values within an address space associated with the AI model. For example, the memory system 110 may include a logical address space that may be allocated for one or more AI models. The memory system 110 may identify, based on the identifier associated with the AI model, the logical address space allocated for the AI model, and may accordingly identify one or more storage locations in which the memory system 110 may store the checkpoint values (e.g., or delta values associated with the checkpoint values). The addresses provided in the one or more commands may be relative to the address space associated with the AI model (e.g., a virtual address space within the logical address space associated with the memory system). The one or more commands may also include an index associated with the checkpoint (e.g., for access using the restore command at a later time).

At 315, the controller 304 of the memory system 110 may compute deltas between the checkpoint values and a corresponding previous value of each of the set of weights. For example, the memory system may retrieve the previous values of the set of weights (e.g., by retrieving one or more initial values of the set of weights and one or more intermediate or previous delta values for each of the set of weights and computing sums of each of the initial values and the corresponding one or more previous delta values). The memory system may compute differences between each of the checkpoint values and the previous values and may quantize (e.g., round) the differences to compute the deltas. In some examples, the memory system 110 may compute the deltas at least partially concurrently with receiving a subset of the one or more commands (e.g., in accordance with a first operation mode). For example, the memory system 110 may receive a set of commands associated with a first checkpoint over a duration, and may compute at least some delta values associated with the first checkpoint during the duration.

At 320, the controller 304 of the memory system 110 may compress the deltas. At 320, the memory system 110 may store the deltas (e.g., in a non-volatile memory 303 or persistent memory of the memory system 110 that is external to the controller 304). The memory system 110 may also store at least some delta values associated with the first checkpoint into the non-volatile memory 303 during the duration over which the commands associated with the first checkpoint are received.

In some examples, at 330, the memory system 110 may identify a trigger to switch operation modes. For example, the memory system 110 may identify a trigger to switch from the first operation mode to a second operation mode. For example, the first operation mode may be associated with computing the deltas at least partially concurrently with receiving a subset of the one or more commands, and the second operation mode may be associated with storing the checkpoint values in a volatile memory of the memory system 110 prior to computing the checkpoint values. Additionally, or alternatively, the memory system 110 may identify a trigger to switch from the second operation mode to the first operation mode. In such examples, the memory system may initially perform the operations 340 through 355 (e.g., in accordance with the second operation mode), may switch to the first operation mode, and may subsequently perform the operations 310 through 325.

In some examples, the trigger may be receiving, at the memory system 110, a user input (e.g., an indication from the host system 105) indicating for the memory system 110 to switch between the first operation mode and the second operation mode; receiving, at the memory system 110, a command to switch between the first operation mode and the second operation mode; identifying that a compression ratio associated with compressing the plurality of deltas satisfies a threshold compression ratio, and/or identifying that a bandwidth saturation of the non-volatile memory 303 satisfies a threshold bandwidth saturation. For example, if a quantity of intermediate delta values used by the memory system 110 to restore a previous checkpoint value (e.g., to compute a delta value as described with reference to 315) is relatively large, the memory system 110 may use relatively more bandwidth of the non-volatile memory 303 as compared to a checkpoint value with relatively fewer intermediate delta values.

At 335, the controller 304 of the memory system 110 may receive one or more additional commands from the host system 105 (e.g., at the memory controller of the memory system 110). The one or more commands may indicate, to the memory system 110, additional checkpoint values for the set of weights of the AI model. For example, the host system 105 may continue to perform the training operation on the AI model to determine one or more updated checkpoint values of the set of weights. The host system 105 may indicate the additional checkpoint values to the memory system 110 for storage during the training operation. The one or more commands may include the identifier associated with the AI model. Additionally, or alternatively, the one or more commands may indicate the checkpoint values within the address space of the AI model.

At 340, the controller 304 of the memory system 110 may store the additional checkpoint values at a volatile memory 302 of the memory system 110 (e.g., in accordance with the second operation mode). In some examples, the volatile memory may be external to the controller 304 of the memory system 110.

At 345, the controller 304 of the memory system 110 may compute additional deltas between the additional checkpoint values and a corresponding previous value of each of the set of weights. For example, the memory system may retrieve the previous values of the set of weights (e.g., by retrieving one or more initial values of the set of weights and one or more previous delta values for each of the set of weights and computing sums of each of the initial values and the corresponding one or more previous delta values) and may read the additional checkpoint values from the volatile memory. In some examples, the previous delta values may include the delta values computed and stored in accordance with the first operation mode. The memory system 110 may compute differences between each of the additional checkpoint values and the previous values and may quantize (e.g., round) the differences to compute the additional deltas.

At 350, the controller 304 of the memory system 110 may compress the additional deltas. At 355, the memory system 110 may store the deltas (e.g., in the non-volatile memory 303 of the memory system 110).

In some examples, at 360, the controller 304 of the memory system 110 may receive a command, from the host system 105, to restore the set of weights. In some examples, the command may be indicated according to the identifier associated with the AI model. In some examples, at 365, the controller 304 of the memory system 110 may restore the set of weights in response to receiving the command to restore the set of weights. For example, the memory system 110 may compute values of the set of weights (e.g., by retrieving one or more initial values of the set of weights and one or more previous delta values for each of the set of weights and computing sums of each of the initial values and the corresponding one or more previous delta values). In some examples, at 370, the memory system 110 may output the set of weights (e.g., the computed sums) to the host system 105.

Additionally, or alternatively, the memory system 110 may receive a command, from the host system 105, to provide the delta values to the host system 105. For example, the memory system 110 may receive a command to decompress one or more of the delta values and provide the decompressed delta values to the host system 105, or to provide a copy of the compressed delta values to the host system 105.

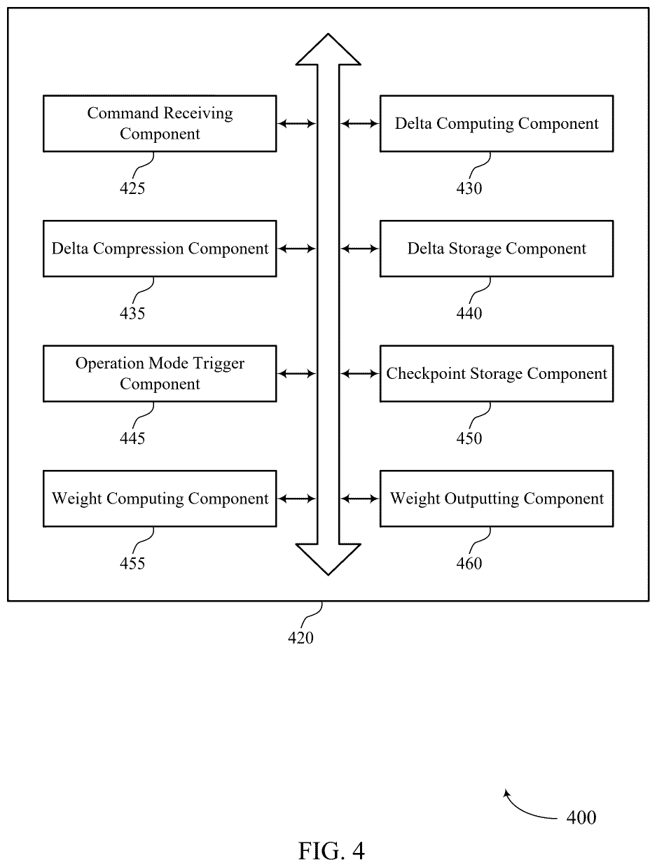

FIG. 4 shows a block diagram 400 of a memory system 420 that supports storing and retrieving checkpoint values using delta computation and compression in accordance with examples as disclosed herein. The memory system 420 may be an example of aspects of a memory system as described with reference to FIGS. 1 through 3. The memory system 420, or various components thereof, may be an example of means for performing various aspects of storing and retrieving checkpoint values using delta computation and compression as described herein. For example, the memory system 420 may include a command receiving component 425, a delta computing component 430, a delta compression component 435, a delta storage component 440, an operation mode trigger component 445, a checkpoint storage component 450, a weight computing component 455, a weight outputting component 460, or any combination thereof. Each of these components, or components of subcomponents thereof (e.g., one or more processors, one or more memories), may communicate, directly or indirectly, with one another (e.g., via one or more buses).

The command receiving component 425 may be configured as or otherwise support a means for receiving, at a memory controller of the memory system, one or more commands indicating a plurality of checkpoint values associated with a set of weights of an artificial intelligence model, where the one or more commands include an identifier associated with the artificial intelligence model and indicate the plurality of checkpoint values within an address space associated with the artificial intelligence model. The delta computing component 430 may be configured as or otherwise support a means for computing, by the memory system, a plurality of deltas between the plurality of checkpoint values and a plurality of previous values associated with the set of weights. The delta compression component 435 may be configured as or otherwise support a means for compressing the plurality of deltas. The delta storage component 440 may be configured as or otherwise support a means for storing the plurality of deltas in a persistent memory of the memory system.

In some examples, to support computing the plurality of deltas, the delta computing component 430 may be configured as or otherwise support a means for computing, in accordance with a first operation mode of the memory system, a subset of the plurality of deltas at least partially concurrently with receiving a subset of the one or more commands.

In some examples, the checkpoint storage component 450 may be configured as or otherwise support a means for storing, by the memory controller, the plurality of checkpoint values in a volatile memory of the memory system that is external to the memory controller, where computing the plurality of deltas is based on reading the plurality of checkpoint values from the volatile memory in accordance with a second operation mode of the memory system.

In some examples, the operation mode trigger component 445 may be configured as or otherwise support a means for identifying a trigger to switch between a first operation mode and a second operation mode, where the first operation mode is associated with computing a subset of the plurality of deltas at least partially concurrently with receiving a subset of the one or more commands, and where the second operation mode includes computing the plurality of deltas based on reading the plurality of checkpoint values from a volatile memory of the memory system that is external to the memory controller.

In some examples, the trigger includes reception of a user input, reception of a command to switch between the first operation mode and the second operation mode, a compression ratio associated with compressing the plurality of deltas satisfying a threshold compression ratio, a bandwidth saturation of the persistent memory associated with the memory system satisfying a threshold bandwidth saturation, or any combination thereof.

In some examples, to support computing the plurality of deltas, the delta computing component 430 may be configured as or otherwise support a means for retrieving the plurality of previous values associated with the set of weights. In some examples, to support computing the plurality of deltas, the delta computing component 430 may be configured as or otherwise support a means for computing a plurality of differences between the plurality of previous values associated with the set of weights and the plurality of checkpoint values. In some examples, to support computing the plurality of deltas, the delta computing component 430 may be configured as or otherwise support a means for quantizing the plurality of differences.

In some examples, to support retrieving the plurality of previous values, the delta computing component 430 may be configured as or otherwise support a means for retrieving one or more initial values associated with the set of weights. In some examples, to support retrieving the plurality of previous values, the delta computing component 430 may be configured as or otherwise support a means for retrieving one or more previous deltas associated with the set of weights. In some examples, to support retrieving the plurality of previous values, the delta computing component 430 may be configured as or otherwise support a means for computing a sum of the one or more initial values and the one or more previous deltas.

In some examples, the command receiving component 425 may be configured as or otherwise support a means for receiving a command to restore the set of weights, where the command is indicated according to the identifier associated with the artificial intelligence model. In some examples, the weight computing component 455 may be configured as or otherwise support a means for computing a set of values associated with the set of weights based on the plurality of deltas. In some examples, the weight outputting component 460 may be configured as or otherwise support a means for outputting the set of values.

In some examples, to support computing the set of values, the weight computing component 455 may be configured as or otherwise support a means for retrieving one or more initial values associated with the set of weights. In some examples, to support computing the set of values, the weight computing component 455 may be configured as or otherwise support a means for retrieving the plurality of deltas. In some examples, to support computing the set of values, the weight computing component 455 may be configured as or otherwise support a means for computing a sum of the one or more initial values and the plurality of deltas.

In some examples, the command receiving component 425 may be configured as or otherwise support a means for receiving, at a memory controller of the memory system, one or more first commands indicating a first plurality of checkpoint values associated with a set of weights of an artificial intelligence model, where the one or more first commands include an identifier associated with the artificial intelligence model and indicate the first plurality of checkpoint values within an address space associated with the artificial intelligence model. In some examples, the delta computing component 430 may be configured as or otherwise support a means for computing, in accordance with a first operation mode of the memory system, a first plurality of deltas, where a subset of the first plurality of deltas are computed at least partially concurrently with receiving a subset of the one or more first commands. In some examples, the delta compression component 435 may be configured as or otherwise support a means for compressing the first plurality of deltas. In some examples, the delta storage component 440 may be configured as or otherwise support a means for storing the first plurality of deltas in a persistent memory of the memory system. The operation mode trigger component 445 may be configured as or otherwise support a means for identifying a trigger to switch between the first operation mode and a second operation mode. In some examples, the command receiving component 425 may be configured as or otherwise support a means for receiving, at the memory controller, one or more second commands indicating a second plurality of checkpoint values associated with the set of weights of the artificial intelligence model. The checkpoint storage component 450 may be configured as or otherwise support a means for storing, by the memory controller, the second plurality of checkpoint values in a volatile memory of the memory system that is external to the memory controller. In some examples, the delta computing component 430 may be configured as or otherwise support a means for computing a second plurality of deltas between the second plurality of checkpoint values and a plurality of previous values associated with the set of weights based on reading the second plurality of checkpoint values from the volatile memory in accordance with the second operation mode. In some examples, the delta compression component 435 may be configured as or otherwise support a means for compressing the second plurality of deltas. In some examples, the delta storage component 440 may be configured as or otherwise support a means for storing the second plurality of deltas in a persistent memory of the memory system.

In some examples, the trigger includes reception of a user input, reception of a command to switch between the first operation mode and the second operation mode, a compression ratio associated with compressing the first plurality of deltas satisfying a threshold compression ratio, a bandwidth saturation of the persistent memory associated with the memory system satisfying a threshold bandwidth saturation, or any combination thereof.

In some examples, to support computing the first plurality of deltas, the delta computing component 430 may be configured as or otherwise support a means for retrieving the plurality of previous values associated with the set of weights. In some examples, to support computing the first plurality of deltas, the delta computing component 430 may be configured as or otherwise support a means for computing a plurality of differences between the plurality of previous values associated with the set of weights and the first plurality of checkpoint values. In some examples, to support computing the first plurality of deltas, the delta computing component 430 may be configured as or otherwise support a means for quantizing the plurality of differences.

In some examples, to support retrieving the plurality of previous values, the delta computing component 430 may be configured as or otherwise support a means for retrieving one or more initial values associated with the set of weights. In some examples, to support retrieving the plurality of previous values, the delta computing component 430 may be configured as or otherwise support a means for retrieving one or more previous deltas associated with the set of weights. In some examples, to support retrieving the plurality of previous values, the delta computing component 430 may be configured as or otherwise support a means for computing a sum of the one or more initial values and the one or more previous deltas.

In some examples, the command receiving component 425 may be configured as or otherwise support a means for receiving a command to restore the set of weights, where the command is indicated according to the identifier associated with the artificial intelligence model. In some examples, the weight computing component 455 may be configured as or otherwise support a means for computing a set of values associated with the set of weights based on the first plurality of deltas and the second plurality of deltas. In some examples, the weight outputting component 460 may be configured as or otherwise support a means for outputting the set of values.

In some examples, to support computing the set of values, the weight computing component 455 may be configured as or otherwise support a means for retrieving one or more initial values associated with the set of weights. In some examples, to support computing the set of values, the weight computing component 455 may be configured as or otherwise support a means for retrieving the first plurality of deltas and the second plurality of deltas. In some examples, to support computing the set of values, the weight computing component 455 may be configured as or otherwise support a means for computing a sum of the one or more initial values, the first plurality of deltas, and the second plurality of deltas.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

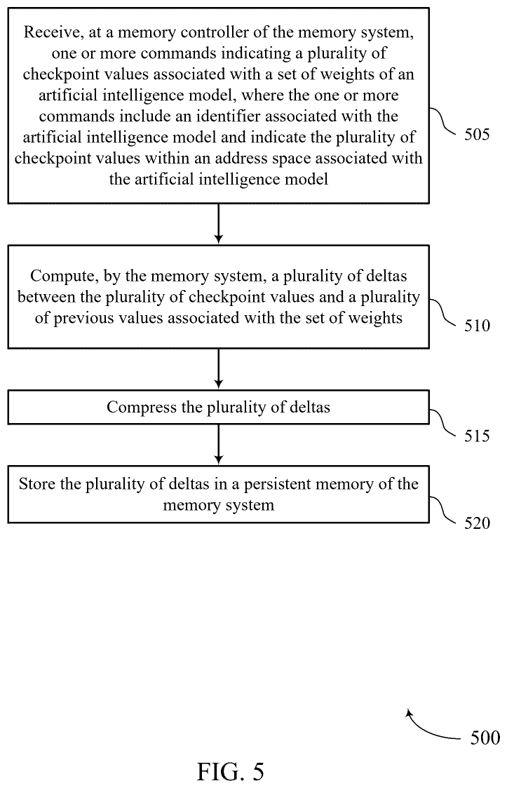

FIG. 5 shows a flowchart illustrating a method 500 that supports storing and retrieving checkpoint values using delta computation and compression in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, at a memory controller of the memory system (e.g., controller(s) 215), one or more commands indicating a plurality of checkpoint values associated with a set of weights of an artificial intelligence model, where the one or more commands include an identifier associated with the artificial intelligence model and indicate the plurality of checkpoint values within an address space associated with the artificial intelligence model. In some examples, aspects of the operations of 505 may be performed by a command receiving component 425 as described with reference to FIG. 4.

At 510, the method may include computing, by the memory system (e.g., by a delta unit 225), a plurality of deltas between the plurality of checkpoint values and a plurality of previous values associated with the set of weights. In some examples, aspects of the operations of 510 may be performed by a delta computing component 430 as described with reference to FIG. 4.

At 515, the method may include compressing the plurality of deltas (e.g., by a compression unit 230). In some examples, aspects of the operations of 515 may be performed by a delta compression component 435 as described with reference to FIG. 4.

At 520, the method may include storing the plurality of deltas in a persistent memory of the memory system (e.g., a non-volatile memory 240). In some examples, aspects of the operations of 520 may be performed by a delta storage component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory controller of the memory system, one or more commands indicating a plurality of checkpoint values associated with a set of weights of an artificial intelligence model, where the one or more commands include an identifier associated with the artificial intelligence model and indicate the plurality of checkpoint values within an address space associated with the artificial intelligence model; computing, by the memory system, a plurality of deltas between the plurality of checkpoint values and a plurality of previous values associated with the set of weights; compressing the plurality of deltas; and storing the plurality of deltas in a persistent memory of the memory system.

Aspect 2: The method, apparatus, or non-transitory computer-readable medium of aspect 1, where computing the plurality of deltas includes operations, features, circuitry, logic, means, or instructions, or any combination thereof for computing, in accordance with a first operation mode of the memory system, a subset of the plurality of deltas at least partially concurrently with receiving a subset of the one or more commands.

Aspect 3: The method, apparatus, or non-transitory computer-readable medium of any of aspects 1 through 2, further including operations, features, circuitry, logic, means, or instructions, or any combination thereof for storing, by the memory controller, the plurality of checkpoint values in a volatile memory of the memory system that is external to the memory controller, where computing the plurality of deltas is based on reading the plurality of checkpoint values from the volatile memory in accordance with a second operation mode of the memory system.

Aspect 4: The method, apparatus, or non-transitory computer-readable medium of any of aspects 1 through 3, further including operations, features, circuitry, logic, means, or instructions, or any combination thereof for identifying a trigger to switch between a first operation mode and a second operation mode, where the first operation mode is associated with computing a subset of the plurality of deltas at least partially concurrently with receiving a subset of the one or more commands, and where the second operation mode includes computing the plurality of deltas based on reading the plurality of checkpoint values from a volatile memory of the memory system that is external to the memory controller.

Aspect 5: The method, apparatus, or non-transitory computer-readable medium of aspect 4, where the trigger includes reception of a user input, reception of a command to switch between the first operation mode and the second operation mode, a compression ratio associated with compressing the plurality of deltas satisfying a threshold compression ratio, a bandwidth saturation of the persistent memory associated with the memory system satisfying a threshold bandwidth saturation, or any combination thereof.

Aspect 6: The method, apparatus, or non-transitory computer-readable medium of any of aspects 1 through 5, where computing the plurality of deltas includes operations, features, circuitry, logic, means, or instructions, or any combination thereof for retrieving the plurality of previous values associated with the set of weights; computing a plurality of differences between the plurality of previous values associated with the set of weights and the plurality of checkpoint values; and quantizing the plurality of differences.

Aspect 7: The method, apparatus, or non-transitory computer-readable medium of aspect 6, where retrieving the plurality of previous values includes operations, features, circuitry, logic, means, or instructions, or any combination thereof for retrieving one or more initial values associated with the set of weights; retrieving one or more previous deltas associated with the set of weights; and computing a sum of the one or more initial values and the one or more previous deltas.

Aspect 8: The method, apparatus, or non-transitory computer-readable medium of any of aspects 1 through 7, further including operations, features, circuitry, logic, means, or instructions, or any combination thereof for receiving a command to restore the set of weights, where the command is indicated according to the identifier associated with the artificial intelligence model; computing a set of values associated with the set of weights based on the plurality of deltas; and outputting the set of values.

Aspect 9: The method, apparatus, or non-transitory computer-readable medium of aspect 8, where computing the set of values includes operations, features, circuitry, logic, means, or instructions, or any combination thereof for retrieving one or more initial values associated with the set of weights; retrieving the plurality of deltas; and computing a sum of the one or more initial values and the plurality of deltas.

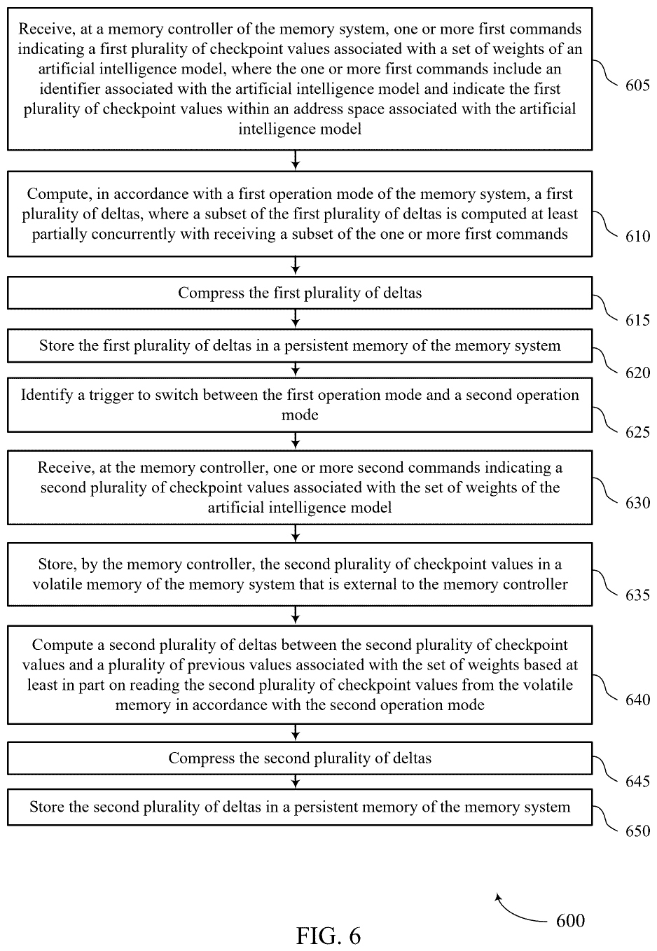

FIG. 6 shows a flowchart illustrating a method 600 that supports storing and retrieving checkpoint values using delta computation and compression in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory controller of the memory system (e.g., controller(s) 215), one or more first commands indicating a first plurality of checkpoint values associated with a set of weights of an artificial intelligence model, where the one or more first commands include an identifier associated with the artificial intelligence model and indicate the first plurality of checkpoint values within an address space associated with the artificial intelligence model. In some examples, aspects of the operations of 605 may be performed by a command receiving component 425 as described with reference to FIG. 4.

At 610, the method may include computing (e.g., by a delta unit 225), in accordance with a first operation mode of the memory system, a first plurality of deltas, where a subset of the first plurality of deltas is computed at least partially concurrently with receiving a subset of the one or more first commands. In some examples, aspects of the operations of 610 may be performed by a delta computing component 430 as described with reference to FIG. 4.

At 615, the method may include compressing the first plurality of deltas (e.g., by a compression unit 230). In some examples, aspects of the operations of 615 may be performed by a delta compression component 435 as described with reference to FIG. 4.

At 620, the method may include storing the first plurality of deltas in a persistent memory of the memory system (e.g., a non-volatile memory 240). In some examples, aspects of the operations of 620 may be performed by a delta storage component 440 as described with reference to FIG. 4.

At 625, the method may include identifying a trigger to switch between the first operation mode and a second operation mode. In some examples, aspects of the operations of 625 may be performed by an operation mode trigger component 445 as described with reference to FIG. 4.

At 630, the method may include receiving, at the memory controller (e.g., controller(s) 215), one or more second commands indicating a second plurality of checkpoint values associated with the set of weights of the artificial intelligence model. In some examples, aspects of the operations of 630 may be performed by a command receiving component 425 as described with reference to FIG. 4.

At 635, the method may include storing, by the memory controller, the second plurality of checkpoint values in a volatile memory of the memory system that is external to the memory controller (e.g., the volatile memory 235). In some examples, aspects of the operations of 635 may be performed by a checkpoint storage component 450 as described with reference to FIG. 4.

At 640, the method may include computing a second plurality of deltas (e.g., by the delta unit 225) between the second plurality of checkpoint values and a plurality of previous values associated with the set of weights based on reading the second plurality of checkpoint values from the volatile memory in accordance with the second operation mode. In some examples, aspects of the operations of 640 may be performed by a delta computing component 430 as described with reference to FIG. 4.

At 645, the method may include compressing the second plurality of deltas (e.g., by the compression unit 230). In some examples, aspects of the operations of 645 may be performed by a delta compression component 435 as described with reference to FIG. 4.

At 650, the method may include storing the second plurality of deltas in a persistent memory of the memory system (e.g., the non-volatile memory 240). In some examples, aspects of the operations of 650 may be performed by a delta storage component 440 as described with reference to FIG. 4.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving, at a memory controller of the memory system, one or more first commands indicating a first plurality of checkpoint values associated with a set of weights of an artificial intelligence model, where the one or more first commands include an identifier associated with the artificial intelligence model and indicate the first plurality of checkpoint values within an address space associated with the artificial intelligence model; computing, in accordance with a first operation mode of the memory system, a first plurality of deltas, where a subset of the first plurality of deltas are computed at least partially concurrently with receiving a subset of the one or more first commands; compressing the first plurality of deltas; storing the first plurality of deltas in a persistent memory of the memory system; identifying a trigger to switch between the first operation mode and a second operation mode; receiving, at the memory controller, one or more second commands indicating a second plurality of checkpoint values associated with the set of weights of the artificial intelligence model; storing, by the memory controller, the second plurality of checkpoint values in a volatile memory of the memory system that is external to the memory controller; computing a second plurality of deltas between the second plurality of checkpoint values and a plurality of previous values associated with the set of weights based on reading the second plurality of checkpoint values from the volatile memory in accordance with the second operation mode; compressing the second plurality of deltas; and storing the second plurality of deltas in a persistent memory of the memory system.

Aspect 11: The method, apparatus, or non-transitory computer-readable medium of aspect 10, where the trigger includes reception of a user input, reception of a command to switch between the first operation mode and the second operation mode, a compression ratio associated with compressing the first plurality of deltas satisfying a threshold compression ratio, a bandwidth saturation of the persistent memory associated with the memory system satisfying a threshold bandwidth saturation, or any combination thereof.

Aspect 12: The method, apparatus, or non-transitory computer-readable medium of any of aspects 10 through 11, where computing the first plurality of deltas includes operations, features, circuitry, logic, means, or instructions, or any combination thereof for retrieving the plurality of previous values associated with the set of weights; computing a plurality of differences between the plurality of previous values associated with the set of weights and the first plurality of checkpoint values; and quantizing the plurality of differences.

Aspect 13: The method, apparatus, or non-transitory computer-readable medium of aspect 12, where retrieving the plurality of previous values includes operations, features, circuitry, logic, means, or instructions, or any combination thereof for retrieving one or more initial values associated with the set of weights; retrieving one or more previous deltas associated with the set of weights; and computing a sum of the one or more initial values and the one or more previous deltas.

Aspect 14: The method, apparatus, or non-transitory computer-readable medium of any of aspects 10 through 13, further including operations, features, circuitry, logic, means, or instructions, or any combination thereof for receiving a command to restore the set of weights, where the command is indicated according to the identifier associated with the artificial intelligence model; computing a set of values associated with the set of weights based on the first plurality of deltas and the second plurality of deltas; and outputting the set of values.

Aspect 15: The method, apparatus, or non-transitory computer-readable medium of aspect 14, where computing the set of values includes operations, features, circuitry, logic, means, or instructions, or any combination thereof for retrieving one or more initial values associated with the set of weights; retrieving the first plurality of deltas and the second plurality of deltas; and computing a sum of the one or more initial values, the first plurality of deltas, and the second plurality of deltas.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, at a memory controller of the memory system, one or more commands indicating a plurality of checkpoint values associated with a set of weights of an artificial intelligence model, wherein the one or more commands comprise an identifier associated with the artificial intelligence model and indicate the plurality of checkpoint values within an address space associated with the artificial intelligence model;
compute, by the memory system, a plurality of deltas between the plurality of checkpoint values and a plurality of previous values associated with the set of weights;
compress the plurality of deltas; and
store the plurality of deltas in a persistent memory of the memory system.

2. The memory system of claim 1, wherein, to compute the plurality of deltas, the processing circuitry is configured to cause the memory system to:
compute, in accordance with a first operation mode of the memory system, a subset of the plurality of deltas at least partially concurrently with receiving a subset of the one or more commands.

3. The memory system of claim 1, wherein the processing circuitry is further configured to cause the memory system to:
store, by the memory controller, the plurality of checkpoint values in a volatile memory of the memory system that is external to the memory controller, wherein computing the plurality of deltas is based on reading the plurality of checkpoint values from the volatile memory in accordance with a second operation mode of the memory system.

4. The memory system of claim 1, wherein the processing circuitry is further configured to cause the memory system to:
identify a trigger to switch between a first operation mode and a second operation mode, wherein the first operation mode is associated with computing a subset of the plurality of deltas at least partially concurrently with receiving a subset of the one or more commands, and wherein the second operation mode comprises computing the plurality of deltas based on reading the plurality of checkpoint values from a volatile memory of the memory system that is external to the memory controller.

5. The memory system of claim 4, wherein the trigger comprises reception of a user input, reception of a command to switch between the first operation mode and the second operation mode, a compression ratio associated with compressing the plurality of deltas satisfying a threshold compression ratio, a bandwidth saturation of the persistent memory associated with the memory system satisfying a threshold bandwidth saturation, or any combination thereof.

6. The memory system of claim 1, wherein, to compute the plurality of deltas, the processing circuitry is configured to cause the memory system to:
retrieve the plurality of previous values associated with the set of weights;
compute a plurality of differences between the plurality of previous values associated with the set of weights and the plurality of checkpoint values; and
quantize the plurality of differences.

7. The memory system of claim 6, wherein, to retrieve the plurality of previous values, the processing circuitry is configured to cause the memory system to:
retrieve one or more initial values associated with the set of weights;
retrieve one or more previous deltas associated with the set of weights; and
compute a sum of the one or more initial values and the one or more previous deltas.

8. The memory system of claim 1, wherein the processing circuitry is further configured to cause the memory system to:
receive a command to restore the set of weights, wherein the command is indicated according to the identifier associated with the artificial intelligence model;
compute a set of values associated with the set of weights based on the plurality of deltas; and
output the set of values.

9. The memory system of claim 8, wherein, to compute the set of values, the processing circuitry is configured to cause the memory system to:
retrieve one or more initial values associated with the set of weights;
retrieve the plurality of deltas; and
compute a sum of the one or more initial values and the plurality of deltas.

10. A memory system, comprising:
one or more memory devices; and
processing circuitry coupled with the one or more memory devices and configured to cause the memory system to:
receive, at a memory controller of the memory system, one or more first commands indicating a first plurality of checkpoint values associated with a set of weights of an artificial intelligence model, wherein the one or more first commands comprise an identifier associated with the artificial intelligence model and indicate the first plurality of checkpoint values within an address space associated with the artificial intelligence model;
compute, in accordance with a first operation mode of the memory system, a first plurality of deltas, wherein a subset of the first plurality of deltas is computed at least partially concurrently with receiving a subset of the one or more first commands;
compress the first plurality of deltas;
store the first plurality of deltas in a persistent memory of the memory system;
identify a trigger to switch between the first operation mode and a second operation mode;
receive, at the memory controller, one or more second commands indicating a second plurality of checkpoint values associated with the set of weights of the artificial intelligence model;
store, by the memory controller, the second plurality of checkpoint values in a volatile memory of the memory system that is external to the memory controller;
compute a second plurality of deltas between the second plurality of checkpoint values and a plurality of previous values associated with the set of weights based on reading the second plurality of checkpoint values from the volatile memory in accordance with the second operation mode;
compress the second plurality of deltas; and
store the second plurality of deltas in the persistent memory of the memory system.

11. The memory system of claim 10, wherein the trigger comprises reception of a user input, reception of a command to switch between the first operation mode and the second operation mode, a compression ratio associated with compressing the first plurality of deltas satisfying a threshold compression ratio, a bandwidth saturation of the persistent memory associated with the memory system satisfying a threshold bandwidth saturation, or any combination thereof.

12. The memory system of claim 10, wherein, to compute the first plurality of deltas, the processing circuitry is configured to cause the memory system to:
retrieve the plurality of previous values associated with the set of weights;
compute a plurality of differences between the plurality of previous values associated with the set of weights and the first plurality of checkpoint values; and
quantize the plurality of differences.

13. The memory system of claim 12, wherein, to retrieve the plurality of previous values, the processing circuitry is configured to cause the memory system to:
retrieve one or more initial values associated with the set of weights;
retrieve one or more previous deltas associated with the set of weights; and
compute a sum of the one or more initial values and the one or more previous deltas.

14. The memory system of claim 10, wherein the processing circuitry is further configured to cause the memory system to:
receive a command to restore the set of weights, wherein the command is indicated according to the identifier associated with the artificial intelligence model;
compute a set of values associated with the set of weights based on the first plurality of deltas and the second plurality of deltas; and
output the set of values.

15. The memory system of claim 14, wherein, to compute the set of values, the processing circuitry is configured to cause the memory system to:
retrieve one or more initial values associated with the set of weights;
retrieve the first plurality of deltas and the second plurality of deltas; and
compute a sum of the one or more initial values, the first plurality of deltas, and the second plurality of deltas.

16. A method by a memory system, comprising:
receiving, at a memory controller of the memory system, one or more commands indicating a plurality of checkpoint values associated with a set of weights of an artificial intelligence model, wherein the one or more commands comprise an identifier associated with the artificial intelligence model and indicate the plurality of checkpoint values within an address space associated with the artificial intelligence model;
computing, by the memory system, a plurality of deltas between the plurality of checkpoint values and a plurality of previous values associated with the set of weights;
compressing the plurality of deltas; and
storing the plurality of deltas in a persistent memory of the memory system.

17. The method of claim 16, wherein computing the plurality of deltas comprises:
computing, in accordance with a first operation mode of the memory system, a subset of the plurality of deltas at least partially concurrently with receiving a subset of the one or more commands.

18. The method of claim 16, further comprising:
storing, by the memory controller, the plurality of checkpoint values in a volatile memory of the memory system that is external to the memory controller, wherein computing the plurality of deltas is based on reading the plurality of checkpoint values from the volatile memory in accordance with a second operation mode of the memory system.

19. The method of claim 16, further comprising:
identifying a trigger to switch between a first operation mode and a second operation mode, wherein the first operation mode is associated with computing a subset of the plurality of deltas at least partially concurrently with receiving a subset of the one or more commands, and wherein the second operation mode comprises computing the plurality of deltas based on reading the plurality of checkpoint values from a volatile memory of the memory system that is external to the memory controller.

20. The method of claim 19, wherein the trigger comprises reception of a user input, reception of a command to switch between the first operation mode and the second operation mode, a compression ratio associated with compressing the plurality of deltas satisfying a threshold compression ratio, a bandwidth saturation of the persistent memory associated with the memory system satisfying a threshold bandwidth saturation, or any combination thereof.

21. The method of claim 16, wherein computing the plurality of deltas comprises:
retrieving the plurality of previous values associated with the set of weights;
computing a plurality of differences between the plurality of previous values associated with the set of weights and the plurality of checkpoint values; and
quantizing the plurality of differences.

22. The method of claim 21, wherein retrieving the plurality of previous values comprises:
retrieving one or more initial values associated with the set of weights;
retrieving one or more previous deltas associated with the set of weights; and
computing a sum of the one or more initial values and the one or more previous deltas.

23. The method of claim 16, further comprising:
receiving a command to restore the set of weights, wherein the command is indicated according to the identifier associated with the artificial intelligence model;
computing a set of values associated with the set of weights based on the plurality of deltas; and
outputting the set of values.

24. The method of claim 23, wherein computing the set of values comprises:
retrieving one or more initial values associated with the set of weights;
retrieving the plurality of deltas; and
computing a sum of the one or more initial values and the plurality of deltas.

25. A method by a memory system, comprising:
receiving, at a memory controller of the memory system, one or more first commands indicating a first plurality of checkpoint values associated with a set of weights of an artificial intelligence model, wherein the one or more first commands comprise an identifier associated with the artificial intelligence model and indicate the first plurality of checkpoint values within an address space associated with the artificial intelligence model;
computing, in accordance with a first operation mode of the memory system, a first plurality of deltas, wherein a subset of the first plurality of deltas are computed at least partially concurrently with receiving a subset of the one or more first commands;
compressing the first plurality of deltas;
storing the first plurality of deltas in a persistent memory of the memory system;
identifying a trigger to switch between the first operation mode and a second operation mode;
receiving, at the memory controller, one or more second commands indicating a second plurality of checkpoint values associated with the set of weights of the artificial intelligence model;
storing, by the memory controller, the second plurality of checkpoint values in a volatile memory of the memory system that is external to the memory controller;
computing a second plurality of deltas between the second plurality of checkpoint values and a plurality of previous values associated with the set of weights based on reading the second plurality of checkpoint values from the volatile memory in accordance with the second operation mode;
compressing the second plurality of deltas; and
storing the second plurality of deltas in the persistent memory of the memory system.

26. The method of claim 25, wherein the trigger comprises reception of a user input, reception of a command to switch between the first operation mode and the second operation mode, a compression ratio associated with compressing the first plurality of deltas satisfying a threshold compression ratio, a bandwidth saturation of the persistent memory associated with the memory system satisfying a threshold bandwidth saturation, or any combination thereof.

27. The method of claim 25, wherein computing the first plurality of deltas comprises:
retrieving the plurality of previous values associated with the set of weights;
computing a plurality of differences between the plurality of previous values associated with the set of weights and the first plurality of checkpoint values; and
quantizing the plurality of differences.

28. The method of claim 27, wherein retrieving the plurality of previous values comprises:
retrieving one or more initial values associated with the set of weights;
retrieving one or more previous deltas associated with the set of weights; and
computing a sum of the one or more initial values and the one or more previous deltas.

29. The method of claim 25, further comprising:
receiving a command to restore the set of weights, wherein the command is indicated according to the identifier associated with the artificial intelligence model;
computing a set of values associated with the set of weights based on the first plurality of deltas and the second plurality of deltas; and
outputting the set of values.

30. A non-transitory computer-readable medium storing code, the code comprising instructions executable by one or more processors to:
receive, at a memory controller of a memory system, one or more commands indicating a plurality of checkpoint values associated with a set of weights of an artificial intelligence model, wherein the one or more commands comprise an identifier associated with the artificial intelligence model and indicate the plurality of checkpoint values within an address space associated with the artificial intelligence model;
compute, by the memory system, a plurality of deltas between the plurality of checkpoint values and a plurality of previous values associated with the set of weights;
compress the plurality of deltas; and
store the plurality of deltas in a persistent memory of the memory system.
